(19) United States
(12) Patent Application Publication
(10) Pub. No.: US 2025/0115192 A1
(43) Pub. Date: Apr. 10, 2025

(54) CAMERA MONITOR SYSTEM

(71) Applicants: HYUNDAI MOTOR COMPANY, Seoul (KR); KIA CORPORATION, Seoul (KR); SL Mirrortech Corporation, Siheung-si (KR)

(72) Inventors: Nak Kyoung Kong, Seongnam-si (KR); Kyung Hwan Kim, Seoul (KR); Sang Heon Wang, Hwaseong-si (KR); Hyun Sub Kim, Seoul (KR); Sung Hyuk Kang, Seoul (KR); Yong Hei Kim, Siheung-si (KR); Won Bin Kim, Siheung-si (KR); Yeong Kook Cho, Siheung-si (KR); Yong Hwan Kim, Siheung-si (KR)

(73) Assignees: HYUNDAI MOTOR COMPANY, Seoul (KR); KIA CORPORATION, Seoul (KR); SL Mirrortech Corporation, Siheung-si (KR)

(21) Appl. No.: 18/654,253

(22) Filed: May 3, 2024

(30) Foreign Application Priority Data
Oct. 4, 2023 (KR) 10-2023-0131364

(51) Int. Cl. B60R 11/04; B60R 1/28; B60R 11/00; G03B 17/56

(52) U.S. Cl. CPC B60R 11/04; B60R 1/28; G03B 17/561; B60R 2011/004; B60R 2011/0082

(57) ABSTRACT

A camera monitor system includes: a panel disposed outside a vehicle, a fixing part fixed to an inner side of the panel, a camera assembly disposed at the fixing part and selectively accommodated in an opening of the panel, and a link unit coupled to the fixing part to transmit driving force of a driving unit to the camera assembly so that the camera assembly selectively protrudes to the outside of the panel.

### CROSS-REFERENCE TO RELATED APPLICATION

This application claims under 35 U.S.C. § 119 (a) the benefit of and priority to Korean Patent Application No. 10-2023-0131364 filed on Oct. 4, 2023, the entire contents of which are incorporated herein by reference.

### BACKGROUND

### (a) Technical Field

The present disclosure relates to a camera monitor system structure located on a vehicle body. More particularly, it relates to a camera monitor system structure capable of protruding a camera assembly outside in response to a user request.

### (b) Background Art

Generally, a driver changes lanes using a side mirror and a rear-view mirror that is disposed at the front center of the vehicle cabin. When a driver changes lanes while watching the side mirror of the driving direction, a collision may occur with a preceding vehicle or a nearby vehicle that is in a blind spot.

In addition, when the vehicle is parked or stopped, the conventional side mirror is folded in a state of protruding to the outside, and thus is damaged by physical impact thereto.

Recently, a camera mirror system (CMS), which displays the external situation of a vehicle on a screen through an external camera lens, has been actively developed.

A vehicle employing such a CMS is configured to capture an image of the external surroundings of the vehicle using an external camera that protrudes to the outside of the vehicle and to display the image captured by the external camera on a display device disposed in the vehicle.

As a related art, a system for protruding an external camera from the outer surface of a vehicle by rotating the same is disclosed. In such a conventional system, an external camera is located at one side of a door of a vehicle and configured to be rotatable so as to protrude to the outside of the door and to be inserted into the door.

However, even when the external camera is inserted into the door, the external camera is still maintained in a state of being exposed to the outside of the door without being completely inserted into the door. For this reason, there is the risk of damage or theft.

Meanwhile, in the case of an external camera configured to be retracted into a door in a folding manner, the protrusion amount of the external camera is limited, and thus, there is a problem in that it is difficult to secure a side rear view.

The above information disclosed in this Background section is provided only to enhance understanding of the background of the present disclosure, and therefore it may contain information that does not form the related art that is already known to a person of ordinary skill in the art.

### SUMMARY

The present disclosure has been made in an effort to solve the above-described problems associated with the related art, and it is an object of the present disclosure to provide a camera monitor system that includes a camera assembly disposed inside a panel of a vehicle and selectively protrudes the camera assembly in response to a user request.

It is another object of the present disclosure to provide a camera monitor system capable of changing a rotation center axis of the camera assembly in linkage with protrusion thereof in order to avoid interference between both ends of the panel of the vehicle and the camera assembly.

The objects of the present disclosure are not limited to the above-mentioned objects, and other objects not mentioned herein should be clearly understood by those having ordinary skill in the art from the following description, and should become apparent with reference to the embodiments of the present disclosure. In addition, the objects of the present disclosure can be accomplished by the components described in the appended claims and combinations thereof.

In one aspect of the present disclosure, a camera monitor system includes: a panel disposed outside a vehicle, a fixing part fixed to an inner side of the panel, and a camera assembly disposed at the fixing part and selectively accommodated in an opening of the panel. The camera monitor system further includes a link unit coupled to the fixing part to transmit driving force of a driving unit to the camera assembly so that the camera assembly selectively protrudes to the outside of the panel.

In an embodiment, the link unit may include a first link coupled to one end of the camera assembly and having a first rotation axis located at the fixing part to transmit driving force to the camera assembly in response to rotational force of the driving unit. The link unit also includes a second link having a second rotation axis located at the fixing part and an end coupled to the camera assembly. The second link may have a rotation amount different from the rotation amount by which the first link is rotated by the driving unit.

In another embodiment, the camera assembly may include a housing protruding to the outside of the panel and a camera unit located at a distal end of the housing.

In still another embodiment, the second link may be coupled to an end of the housing located far from the driving unit and may be configured to change a rotation center axis of the housing in response to rotation of the housing coupled to the first link.

In yet another embodiment, the protrusion amount of the front end of the housing located adjacent to the driving unit may be less than the protrusion amount of the rear end of the housing.

In still yet another embodiment, the first rotation axis may be located at a position farther away from the camera assembly than the second rotation axis.

In a further embodiment, the camera monitor system may further include a stopper located on a rotation trajectory of the first link to limit rotation of the first link.

In another further embodiment, the camera monitor system may further include a controller configured to control the rotation amount of the driving unit in order to rotate the camera assembly.

In still another further embodiment, when the first link is moved to a position contacting the stopper, the controller may measure a stall current of the driving unit. When the measured stall current is equal to or greater than a predetermined value, the controller may stop operation of the driving unit.

In yet another embodiment, the camera monitor system may further include a support portion disposed in the fixing part so as to face the lower surface of the housing in order to support the lower surface of the housing.

In another aspect of the present disclosure, a camera monitor system includes: a fixing part fixed to an inner side of a panel of a vehicle, a camera assembly disposed at the fixing part to selectively protrude, and a link unit coupled to the fixing part to transmit driving force of a driving unit to the camera assembly such that the protrusion amount of the front end of the camera assembly to the outside of the panel is less than the protrusion amount of the rear end of the camera assembly.

In an embodiment, the link unit may include a first link coupled to one end of the camera assembly and having a first rotation axis located at the fixing part to transmit driving force to the camera assembly in response to rotational force of the driving unit. The link unit also includes a second link having a second rotation axis located at the fixing part and an end coupled to the camera assembly. The second link may have a rotation amount different from the rotation amount by which the first link is rotated by the driving unit.

In another embodiment, the camera assembly may include: a housing protruding to the outside of the panel, and a camera unit located at a distal end of the housing.

In still another embodiment, the second link may be coupled to an end of the housing located far from the driving unit and may be configured to change a rotation center axis of the housing in response to rotation of the housing coupled to the first link.

In yet another embodiment, the camera monitor system may further include a stopper located on a rotation trajectory of the first link to limit rotation of the first link.

In still yet another embodiment, the camera monitor system may further include a controller configured to control the rotation amount of the driving unit in order to rotate the camera assembly.

In a further embodiment, when the first link is moved to a position contacting the stopper, the controller may measure a stall current of the driving unit. When the measured stall current is equal to or greater than a predetermined value, the controller may stop operation of the driving unit.

In another further embodiment, the camera monitor system may further include a garnish portion formed along an edge of the housing so as to surround an opening of the panel.

Other aspects and embodiments of the present disclosure are further discussed below.

It is understood that the term “vehicle” or “vehicular” or other similar terms as used herein are inclusive of motor vehicles in general such as passenger automobiles including sport utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the present disclosure are discussed below.

### BRIEF DESCRIPTION OF THE DRAWINGS

The above and other features of the present disclosure are now described in detail with reference to certain embodiments thereof illustrated in the accompanying drawings which are given hereinbelow by way of illustration only, and thus are not limitative of the present disclosure, and wherein:

FIG. 1A is a view showing a state in which a camera monitor system according to an embodiment of the present disclosure is accommodated inside a panel;

FIG. 1B is a view showing a state in which the camera monitor system according to the embodiment of the present disclosure protrudes to the outside of an opening of the panel;

FIG. 1C is a view showing the camera monitor system mounted inside the panel, according to the embodiment of the present disclosure;

FIG. 2 is a view showing components of the camera monitor system according to an embodiment of the present disclosure;

FIG. 3A is a view showing the configuration of the camera monitor system, according to the embodiment of the present disclosure, in a state of being accommodated inside the panel;

FIG. 3B is an outer side view of the camera monitor system, according to the embodiment of the present disclosure, in a state of being accommodated inside the panel;

FIG. 4A is a view showing the configuration of the camera monitor system, according to the embodiment of the present disclosure, in a state of protruding to the outside of the panel;

FIG. 4B is an outer side view of the camera monitor system, according to the embodiment of the present disclosure, in a state of protruding to the outside of the panel;

FIG. 5A is a top view of a camera assembly, according to the embodiment of the present disclosure, in a state of protruding to the outside of the panel;

FIG. 5B is a view showing a rotation center axis of the camera assembly according to an embodiment of the present disclosure; and

FIG. 5C is a view showing a relationship between the opening of the panel and a housing, according to the embodiment of the present disclosure, in a state of protruding to the outside of the panel.

It should be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes, should be determined in part by the particular intended application and use environment.

In the figures, the same reference numbers are used to refer to the same or equivalent parts of the present disclosure throughout the several figures of the drawing.

### DETAILED DESCRIPTION

Hereinafter, some embodiments of the present disclosure are described in detail with reference to the accompanying drawings. The present disclosure may, however, be embodied in many different forms, and should not be construed as being limited to the embodiments set forth herein. Rather, these embodiments are provided so that the present disclosure should be thorough and complete, and should fully convey the scope of the present disclosure to those having ordinary skill in the art.

The terms “-part”, “-unit”, and “-assembly” used in the specification mean units for processing at least one function or operation, and can be implemented as hardware components, software components, or combinations of hardware components and software components.

Further, in the following description, the terms “first” and “second” are used only to avoid confusing designated components, and do not indicate the sequence or importance of the components or the relationships between the components.

In addition, in the present specification, a controller 400 is an electronic control unit (ECU) belonging to the ECU level, and may be a device integrally controlling multiple electronic devices used in a vehicle. For example, the controller 400 may control all of processors belonging to the processor level and controllers belonging to the controller level. The controller 400 may receive sensing data from the processors, may generate a control command for control of a controller in consideration of circumstances, and may transmit the control command to the controllers. In the present specification, for convenience of explanation, the ECU level is described as a higher level than the processor level, however, there may be a case in which one of the processors belonging to the processor level serves as an ECU, or a case in which two processors are combined to serve as an ECU.

The present disclosure relates to a camera monitor system accommodated inside a panel 10 of a vehicle. At least a portion of the camera monitor system protrudes from the panel 10 in response to a user request or environmental change during travel of the vehicle in order to provide an image of the area located at the side rear of the vehicle to a driver.

According to an embodiment of the present disclosure, the camera monitor system may be located on the panel 10 that forms the outer surface of the vehicle, and may be configured to form the outer surface of the panel 10 in a state of being accommodated inside the panel 10.

Hereinafter, the camera monitor system according to the embodiment of the present disclosure is described as having a structure capable of being accommodated inside a front fender 10. However, the present disclosure is not limited to any specific position at which the camera monitor system is mounted. The camera monitor system may be mounted in the external panel 10 of the vehicle, so long as the same is capable of providing an image of the area located at the side rear of the vehicle.

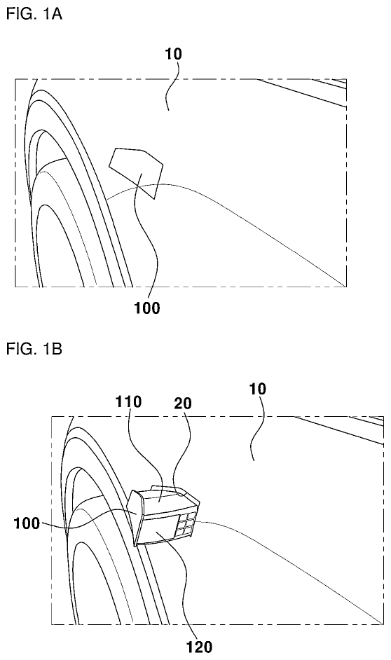

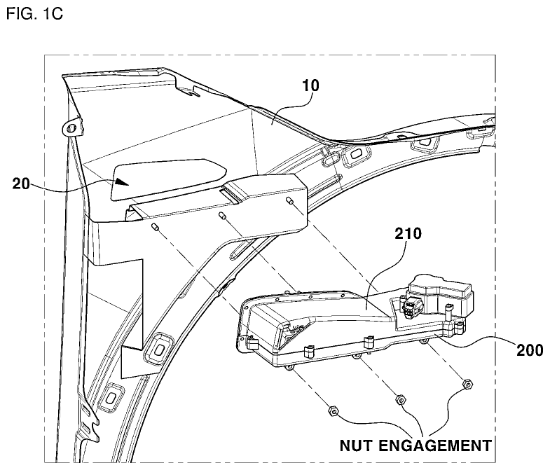

FIG. 1A is a view showing a state in which the camera monitor system according to an embodiment of the present disclosure is accommodated inside the front fender 10. FIG. 1B is a view showing a state in which the camera monitor system protrudes from the outer surface of the front fender 10.

As shown in the drawings, the camera monitor system located at the front fender 10 is configured to selectively protrude. A camera assembly 100 located at the rear end of the camera monitor system may protrude so as to face the side rear of the vehicle or face the lower end of the side surface of the vehicle.

Further, the camera monitor system is configured to be inserted into and accommodated inside the front fender 10 such that the outer surface of the camera monitor system is coplanar with the outer surface of the front fender 10.

The camera monitor system protrudes to the outside of the front fender 10 in such a manner that a housing 110 of the camera assembly 100 including a camera unit 120 is rotated about a fixing part 200 located inside the front fender 10.

In one embodiment, the fixing part 200 is fixedly located inside the front fender 10. The camera monitor system includes an upper cover 210 disposed on the upper surface of the fixing part 200, and the camera monitor system is coupled to the inner surface of the panel 10 by means of nuts during vehicle assembly. As shown in FIG. 1C, the panel 10 is provided on the inner surface thereof with three nut engagement portions, and the camera monitor system, which includes the fixing part 200 and the upper cover 210, is fixed to the inner surface of the panel 10 by engaging nuts with the nut engagement portions.

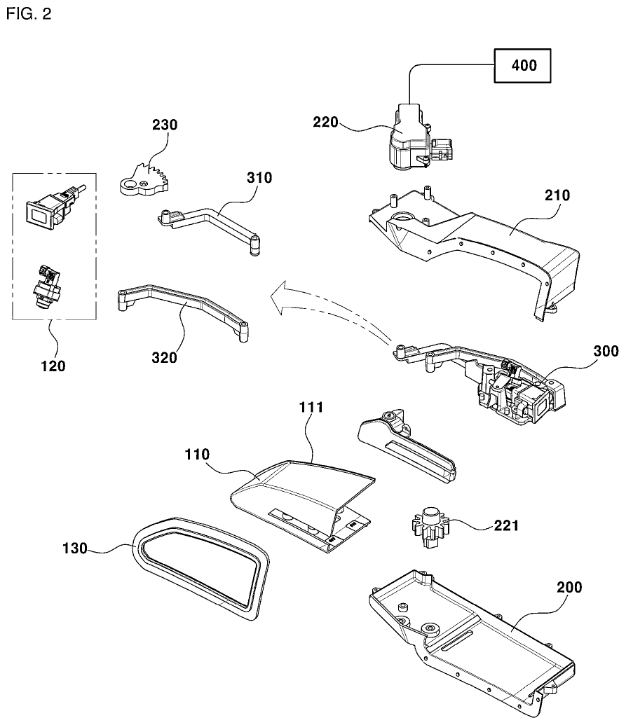

FIG. 2 is a view showing the configuration of the camera monitor system of the present disclosure.

As shown in the drawing, the camera monitor system includes a fixing part 200 and an upper cover 210. In addition, the camera monitor system includes a camera assembly 100 that is located on the fixing part 200 and is configured to protrude from the outer surface of the panel 10. The camera monitor system includes a link unit 300 configured to transmit rotational force of a driving unit 220 to the camera assembly 100.

The driving unit 220 includes any of devices configured to generate rotational force, such as an actuator or a motor. In addition, the camera monitor system includes a driving gear 221 coupled to a rotating shaft of the driving unit 220 and a transmission gear 230 engaged with the driving gear 221 to apply rotational force of the driving unit 220 to the link unit 300.

The link unit 300 is configured to transmit driving force of the driving unit 220 to the camera assembly 100. In another embodiment, the link unit 300 includes a first link 310 that is located coaxially with the transmission gear 230 engaged with the driving gear 221 of the driving unit 220 and integrally rotates along with rotation of the transmission gear 230. The link unit 300 further includes a second link 320 that is located adjacent to the first link 310 and coupled to the camera assembly 100.

The first link 310 is located between the transmission gear 230 and the camera assembly 100. The second link 320 includes one end that is spaced apart from the transmission gear 230 and fixed to a portion of the fixing part 200 that is adjacent to the camera assembly 100. Another end of the second link 320 is far away from the other end of the first link 310 coupled to the camera assembly 100 and is coupled to a portion of the camera assembly 100 close to the rear end of the camera assembly 100.

In other words, a first rotation axis 311 of the first link 310 is coaxial with the transmission gear 230 that receives driving force of the driving unit 220, and a second rotation axis 321 of the second link 320 is spaced apart from the transmission gear 230. In particular, the second rotation axis 321 is located at a position adjacent to the camera assembly 100. Further, the first rotation axis 311 is located at a position in the fixing part 200 that is closer to the front outer surface of the vehicle than the second rotation axis 321.

As described above, the first link 310 of the link unit 300 is coupled to one end of the camera assembly 100 and transmits driving force to the camera assembly 100 according to the rotational force of the driving unit 220. Further, the second rotation axis 321 of the second link 320 is located in the fixing part 200, and one end of the second link 320 is coupled to the camera assembly 100 such that the camera assembly 100 has a rotation amount different from the rotation amount by which the first link 310 is rotated by the driving unit 220.

One end of the first link 310 that is coupled to the camera assembly 100 and both ends of the second link 320 are formed to be rotatable freely. When the first link 310 is rotated about the first rotation axis 311, the other end of the first link 310 and the other end of the second link 320, which are coupled to the housing 110, guide the housing 110 to perform sliding movement as well as rotation.

When the rotational force of the driving unit 220 is applied to the first link 310, the second link 320 may function to guide the housing 110 such that a rotation center axis 30 of the housing 110 moves closer to the front side of the vehicle than the rotation axis of the first link 310. Therefore, when the rotational force of the first link 310 is applied to the housing 110, the second link 320 guides the housing 110 such that the rotation center axis 30 of the housing 110 moves forward to a position farther away from the housing 110 than the first rotation axis 311, and thus the rotation amount of the housing 110 is reduced. As a result, the housing 110 has a large radius of rotation so as to avoid interference with an opening 20 of the panel 10.

In addition, the fixing part 200 includes a support portion 201 formed at a position facing the lower surface of the housing 110 in order to support the lower surface of the housing 110.

In addition, the camera assembly 100 of the present disclosure includes a housing 110 formed so as to protrude to the outside of the panel 10, a camera unit 120 located at the distal end of the housing 110, and a garnish portion 130 formed to cover a gap between the housing 110 and the panel 10 along the edge of the opening 20 of the panel 10. The garnish portion 130 may function to prevent introduction of foreign substances or rainwater into the gap.

The housing 110 includes a housing rib 111 formed on the inner end thereof so as to face the inner side of the opening 20 of the panel 10. The housing rib 111 extends outward along the edge of the inner end of the housing 110. In the state in which the housing 110 is deployed, the housing rib 111 is in contact with the inner side of the panel 10 or the garnish portion 130. In addition, the housing 110 may further include a cover cap (not shown) formed at a position where the housing rib 111 faces the inner side of the panel 10.

Furthermore, the housing rib 111 exhibits the effect of preventing occurrence of wind noise due to the gap between the panel 10 and the housing 110 when the housing 110 is deployed.

In one embodiment, the camera unit 120 includes at least one of a surround view monitor camera, a digital side mirror camera, or an infrared camera. Images of the side rear area and the side lower area around the vehicle captured by the camera unit 120 are displayed on at least one display unit provided in the interior space of the vehicle to be provided to a user. In addition, the garnish portion 130 is formed along the edge of the housing 110 so as to surround the opening 20 of the panel 10.

Therefore, when the camera unit 120 protrudes to the outside of the panel 10 integrally with the housing 110, it is possible to provide not only an image of the side rear area around the vehicle but also a surround view monitor image to a user in the vehicle.

The driving unit 220 is mounted to the panel 10 or the fixing part 200. The rotating shaft of the driving unit 220 penetrates the upper end of the fixing part 200 and is coupled to the driving gear 221 so that the driving gear 221 integrally rotates with the rotating shaft of the driving unit 220. Because the transmission gear 230 located coaxially with the first rotation axis 311 of the first link 310 is engaged with the driving gear 221, the rotational force of the driving gear 221 is transmitted to the transmission gear 230, and thus the first link 310 is rotated about the first rotation axis 311.

The second link 320 is coupled to a portion of the housing 110 that is adjacent to the rear end of the housing 110 and includes a second rotation axis 321. The second rotation axis 321 is formed at one end thereof that is closer to the housing 110 than the first rotation axis 311. The second link 320 functions to change the position of the rotation center axis 30 of the housing 110 when the first link 310 is rotated. In other words, the second link 320 guides movement of the housing 110 in the width direction so that the camera assembly 100 does not interfere with the opening 20 of the panel 10 when protruding to the outside of the panel 10. Due to the second link 320, when the housing 110 protrudes to the outside of the panel 10, the housing 110 is rotated about the rotation center axis 30 that is located at a position farther forward than the first rotation axis 311. Accordingly, the actual rotation amount of the housing 110 is less than when the housing 110 is rotated about the first rotation axis 311. Further, when the housing 110 protrudes to the outside of the panel 10, the protrusion amount of one end of the housing 110 that is adjacent to the driving unit 220 is less than the protrusion amount of the other end of the housing 110. In other words, the housing 110 is rotated about the virtual rotation center axis 30 that is closer to the front side of the vehicle than the first rotation axis 311. Therefore, the distal end of the housing 110 that is located far from the rotation center axis 30 has a greater protrusion amount than the front end of the housing 110.

In addition, the controller 400 may control the camera monitor system to protrude to the outside of the panel 10 in consideration of a user request or a driving environment. In other words, the controller 400 may control operation of the driving unit 220 such that the driving force of the driving unit 220 is activated and deactivated. The controller 400 may control operation of the camera unit 120 of the camera monitor system after the camera monitor system protrudes to the outside of the panel 10.

In addition, the controller 400 may measure a stall current of the driving unit 220. Therefore, when the first link 310 comes into contact with a stopper 240 located on a rotation trajectory of the first link 310 and thus further rotation thereof is restricted. In other words, upon determining that the stall current of the driving unit 220 is equal to or greater than a predetermined value, the controller 400 performs control such that the driving unit 220 is turned off.

In this way, the stopper 240 is located within the radius of rotation of the first link 310 to limit the rotation of the first link 310 so that the protrusion amount of the camera assembly 100 does not exceed the maximum allowable protrusion amount. Further, when the first link 310 is not rotated by contact with the stopper 240, the controller 400 measures the stall current of the driving unit 220, and turns off the driving unit 220, thereby preventing application of overcurrent to the driving unit 220.

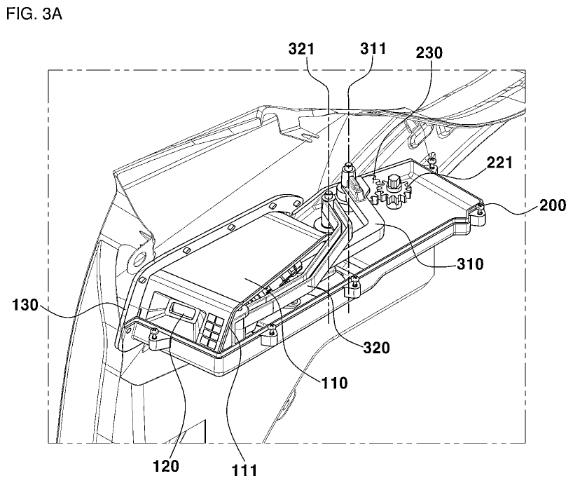

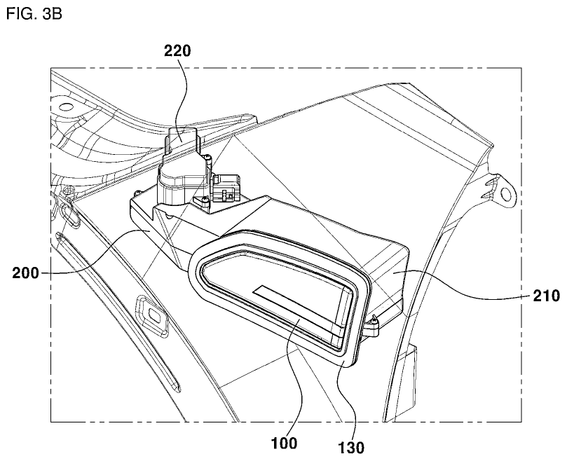

FIGS. 3A and 3B are views showing a state in which the camera monitor system is accommodated inside the opening 20 of the panel 10.

In the state in which the camera monitor system is accommodated inside the panel 10, the outer surface of the panel 10 and the outer surface of the housing 110 located in the opening 20 of the panel 10 are coplanar with each other. Also, the driving unit 220 is in an off state, and the link unit 300 is in a state of being fixed at the initial position in the fixing part 200.

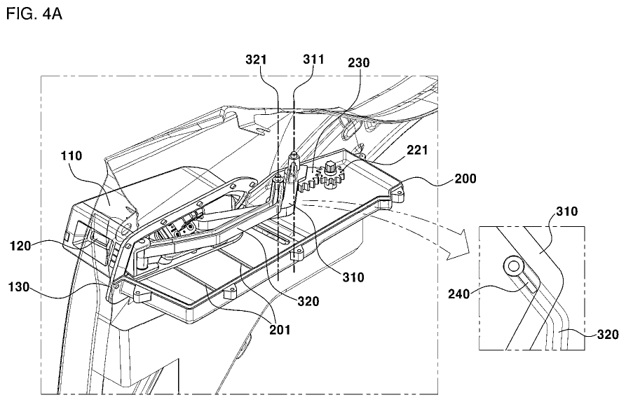

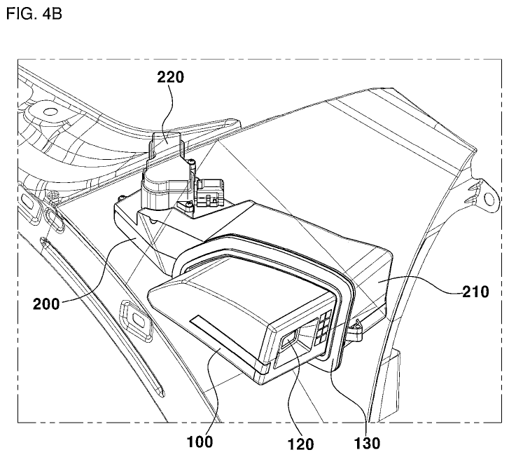

Thereafter, as shown in FIGS. 4A and 4B, upon receiving a user request or upon determining that there is a change in the driving environment, for example, when the speed of the vehicle becomes equal to or greater than a predetermined speed or when the vehicle is turned on, the controller 400 turns on the driving unit 220 so that the camera assembly 100 protrudes to the outside of the panel 10.

At this time, the controller 400 applies power to the driving unit 220 and turns on the camera unit 120. In response to rotation of the driving unit 220, the transmission gear 230 engaged with the driving gear 221 is rotated, and the first link 310 is rotated about the first rotation axis 311 located coaxially with the transmission gear 230. In this way, as the first link 310 including the first rotation axis 311 is rotated by the operation of the driving unit 220, the other end of the first link 310 coupled to the camera assembly 100 is rotated to the outside of the vehicle, whereby the housing 110 protrudes to the outside of the opening 20 of the panel 10.

When the housing 110 is rotated by the rotational force of the first link 310, the second link 320, which is a guide link, reduces the radius of rotation of the housing 110. In other words, the housing 110 is not rotated about the first rotation axis 311 to which the rotational force of the driving unit 220 is applied, and the rotation center axis 30 of the housing 110 is moved to a predetermined position closer to the front side of the vehicle than the first rotation axis 311 due to the first rotation axis 311 and the second rotation axis 321. When the driving force of the driving unit 220 is applied to the housing 110, the rotation center axis 30 of the housing 110 is located at a position farther forward than the first rotation axis 311.

Therefore, when the housing 110 protrudes to the outside of the opening 20 of the panel 10, the housing 110 is rotated about the rotation center axis 30 formed by the fixed axes of the first link 310 and the second link 320. In other words, when the housing 110 is rotated about the rotation center axis 30 formed by the fixed axes of the first link 310 and the second link 320, the radius of rotation thereof is less than when the housing 110 is rotated about the first rotation axis 311. Accordingly, the housing 110 is rotated without interference with the front and rear ends of the opening 20.

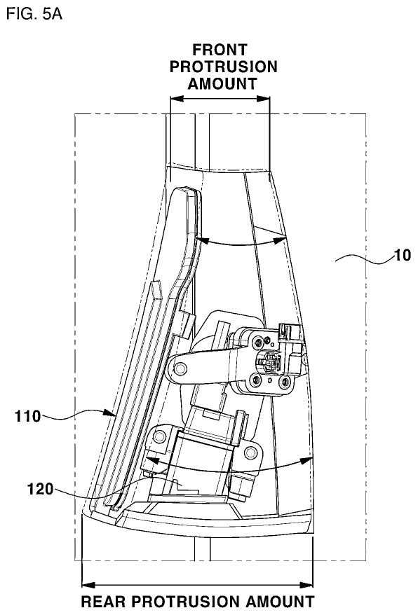

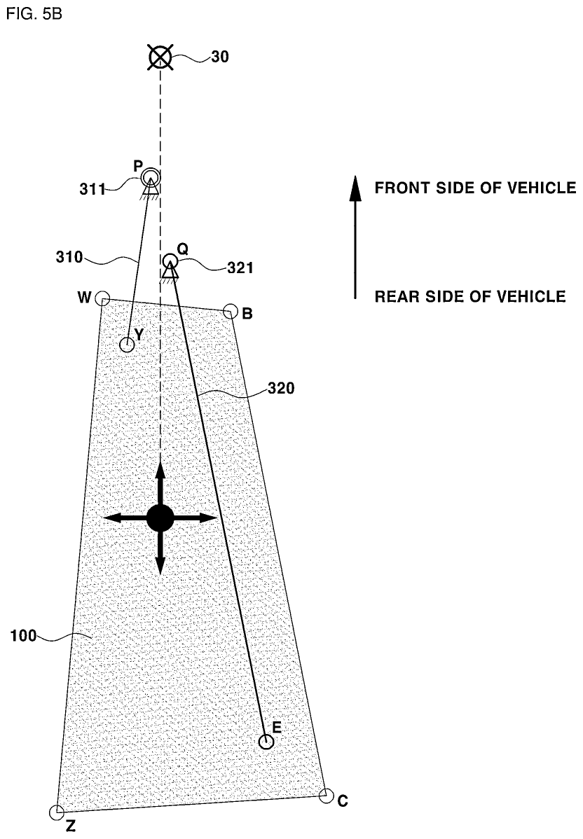

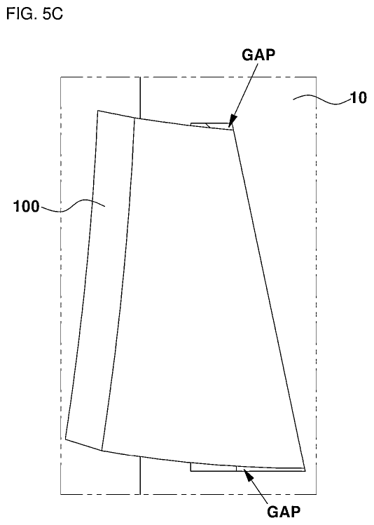

FIG. 5A is a view showing the protrusion amount of the camera assembly 100 that protrudes to the outside of the opening according to an embodiment of the present disclosure.

As shown in the drawing, when the camera assembly 100 protrudes to the outside of the opening 20, the rear end of the housing 110 has a greater protrusion amount than the front end thereof. In other words, since the housing 110 is rotated about the rotation center axis 30 formed by the first rotation axis 311 and the second rotation axis 321, the rear end of the housing 110 that is located relatively far from the rotation center axis 30 has a greater protrusion amount than the front end thereof. Because the camera unit 120 located at the rear end of the housing 110 protrudes from the side surface of the vehicle, it is possible to capture images of the side rear area and the side lower area around the vehicle.

Further, as shown in FIGS. 5B and 50, when the camera assembly 100 protrudes, the camera assembly 100 is rotated about the rotation center axis 30 formed by the fixed axes of the first link 310 and the second link 320, i.e., the first rotation axis 311 and the second rotation axis 321 located in the fixing part 200. In other words, the rotation center axis 30 of the housing 110 is located at a position closer to the front side of the vehicle than the first rotation axis 311 and the second rotation axis 321. Therefore, the housing 110 is rotated with a smaller radius of rotation than when rotated about the driving unit 220, and thus is moved to the outside of the opening 20 in the lateral direction without interference.

Therefore, as shown in FIG. 5C, the front end of the housing 110 in the longitudinal direction has a rotation amount that does not interfere with the opening 20 of the panel 10, and the rear end of the housing 110 has a greater protrusion amount than the front end thereof. Further, it is possible to provide images of the side rear area and the side lower area around the vehicle to a user through the camera unit 120 located at the rear end of the housing 110.

Further, as shown in FIG. 5C, in the state in which the housing 110 is deployed, constant gaps are maintained between the front and rear ends of the housing 110 and the panel 10. When the housing 110 is deployed in the width direction of the vehicle, a constant gap may be maintained between the panel 10 and the housing 110 regardless of the movement of the housing 110.

As is apparent from the above description, the present disclosure exhibits the following effects through the above embodiments and through the configurations and combination and use relationships described above.

The present disclosure may provide a camera monitor system capable of being located inside a panel of a vehicle body depending on a driving environment. Therefore, it may be possible to provide a camera monitor system safe against an external environment of a vehicle.

In addition, the present disclosure may provide a camera monitor system located in an opening area of a panel of a vehicle and a camera assembly configured to protrude to the outside of the opening of the panel, thereby providing a wider rear view.

In addition, it may be possible to change a rotation center axis of a camera assembly in order to avoid interference with an opening of a panel, thereby improving the durability of a camera monitor system.

In addition, a camera assembly of the present disclosure may be configured such that the front portion thereof and the rear portion thereof have different protrusion amounts. Therefore, it may be possible to minimize running resistance of a vehicle, thereby improving fuel efficiency and reducing occurrence of wind noise.

The above description is illustrative of the present disclosure. Also, the above disclosure is intended to illustrate and explain embodiments of the present disclosure, and the present disclosure may be used in various other combinations, modifications, and environments. In other words, the present disclosure may be changed or modified within the scope of the concept of the present disclosure disclosed herein, within the equivalent scope of the disclosure, and/or within the skill and knowledge of the art. The described embodiments illustrate the best state of the art to implement the technical idea of the present disclosure, and various changes may be made thereto as demanded for specific applications and uses of the present disclosure. Accordingly, the above description is not intended to limit the present disclosure to the embodiments. Also, the appended claims should be construed as encompassing such other embodiments.

What is claimed is:

1. A camera monitor system comprising:
a panel disposed outside a vehicle;
a fixing part fixed to an inner side of the panel;
a camera assembly disposed at the fixing part and selectively accommodated in an opening of the panel; and
a link unit coupled to the fixing part to transmit driving force of a driving unit to the camera assembly so that the camera assembly selectively protrudes to an outside of the panel.

2. The camera monitor system of claim 1, wherein the link unit comprises:
a first link coupled to one end of the camera assembly, the first link having a first rotation axis located at the fixing part to transmit the driving force to the camera assembly; and
a second link having a second rotation axis located at the fixing part and an end coupled to the camera assembly, and
wherein the second link has a rotation amount different from a rotation amount by which the first link is rotated by the driving unit.

3. The camera monitor system of claim 2, wherein the camera assembly comprises:
a housing protruding to the outside of the panel; and
a camera unit located at a distal end of the housing.

4. The camera monitor system of claim 3, wherein the second link is coupled to an end of the housing located far from the driving unit and is configured to change a rotation center axis of the housing in response to rotation of the housing coupled to the first link.

5. The camera monitor system of claim 3, wherein a protrusion amount of a front end of the housing located adjacent to the driving unit is less than a protrusion amount of a rear end of the housing.

6. The camera monitor system of claim 2, wherein the first rotation axis is located at a position farther away from the camera assembly than the second rotation axis.

7. The camera monitor system of claim 2, further comprising a stopper located on a rotation trajectory of the first link to limit rotation of the first link.

8. The camera monitor system of claim 1, further comprising a controller configured to control a rotation amount of the driving unit in order to rotate the camera assembly.

9. The camera monitor system of claim 8, wherein the link unit includes a first link having a first rotation axis located at the fixing part to transmit the driving force to the camera assembly, wherein when the first link is moved to a position contacting a stopper, the controller measures a stall current of the driving unit, and
wherein, when the measured stall current is equal to or greater than a predetermined value, the controller stops operation of the driving unit.

10. The camera monitor system of claim 3, further comprising a support portion disposed in the fixing part so as to face a lower surface of the housing in order to support the lower surface of the housing.

11. A camera monitor system comprising:
a fixing part fixed to an inner side of a panel of a vehicle;
a camera assembly disposed at the fixing part to selectively protrude; and
a link unit coupled to the fixing part to transmit driving force of a driving unit to the camera assembly such that a protrusion amount of a front end of the camera assembly to an outside of the panel is less than a protrusion amount of a rear end of the camera assembly.

12. The camera monitor system of claim 11, wherein the link unit comprises:
a first link coupled to one end of the camera assembly, the first link having a first rotation axis located at the fixing part to transmit the driving force to the camera assembly; and
a second link having a second rotation axis located at the fixing part and an end coupled to the camera assembly, and
wherein the second link has a rotation amount different from a rotation amount by which the first link is rotated by the driving unit.

13. The camera monitor system of claim 12, wherein the camera assembly comprises:
a housing protruding to the outside of the panel; and
a camera unit located at a distal end of the housing.

14. The camera monitor system of claim 13, wherein the second link is coupled to an end of the housing located far from the driving unit and is configured to change a rotation center axis of the housing in response to rotation of the housing coupled to the first link.

15. The camera monitor system of claim 12, further comprising a stopper located on a rotation trajectory of the first link to limit rotation of the first link.

16. The camera monitor system of claim 11, further comprising a controller configured to control a rotation amount of the driving unit in order to rotate the camera assembly.

17. The camera monitor system of claim 16, wherein the link unit includes a first link having a first rotation axis located at the fixing part to transmit the driving force to the camera assembly, wherein when the first link is moved to a position contacting a stopper, the controller measures a stall current of the driving unit, and
wherein, when the measured stall current is equal to or greater than a predetermined value, the controller stops operation of the driving unit.

18. The camera monitor system of claim 13, further comprising a garnish portion formed along an edge of the housing so as to surround an opening of the panel.
